(19) United States
(12) Patent Application Publication
(10) Pub. No.: US 2003/0006896 A1
(43) Pub. Date: Jan. 9, 2003

(54) Brake wear sensor

(76) Inventor: Michael F. Passwater, South Bend, IN (US)

Correspondence Address: CTS CORPORATION, 905 W. BLVD. N, ELKHART, IN, 46502, US

(21) Appl. No.: 09/896,511

(22) Filed: Jun. 29, 2001

(51) Int. Cl. B60Q 1/00

(52) U.S. Cl. 340/454; 340/657

(57) ABSTRACT

A brake wear sensor is provided for generating an electrical signal representative of a brake wear condition. The sensor incorporates a plurality of resistors electrically interconnected in parallel. As the brake pad surface is worn, the brake wear sensor suffers a corresponding decrease in length. The decrease in length can be determined from the change in the equivalent resistance of the plurality of resistors. A particular wear condition requiring service can be sensed or, in the alternative, it is possible to determine the expected life remaining in the brake pad.

### FIELD OF THE INVENTION

This invention relates to sensors for detecting wear in an automotive brake. This invention relates more particularly to brake wear sensors incorporating an electric resistance element.

### BACKGROUND OF THE INVENTION

Braking systems in automobiles typically include a pad that is forced against a rotor or a drum. The rotor rotates with the wheel of the vehicle and the pad is forced against the rotor or drum when braking is desired. The friction of the pad against the rotor or drum slows and stops the vehicle.

Over time, the pad will wear down. For this reason, automobile manufacturers recommend brake inspections at service intervals. They also recommend brake pad rotation or replacement for certain conditions. Unfortunately, not all vehicle owners follow the suggested maintenance of the manufacturer. When these guidelines are not followed, it is possible for the brake pad to wear to the point of brake failure.

To avoid this dangerous condition, various schemes have been utilized to provide an indication of brake wear. For example, in U.S. Pat. No. 5,117,947, a metallic piece is placed so as to come into contact with the rotor upon the brake pad wearing to a predefined point. In this type of warning indicator, the vehicle operator will hear an unpleasant sound when brakes are applied as the metal indicator piece comes into contact with the rotor. Typically, operators at this point will seek service on the vehicle.

Increasingly, automobiles utilize electrical and electronic control and indication systems. It is a shortcoming of the prior systems that no electrical indication of the wear situation is provided. It is a further shortcoming that the sole indication of the wear is provided when the brake pad wears beyond a set point requiring service. No indication is provided of the remaining life of the pad prior to this. It is a further shortcoming of the prior systems that they provide only an audible warning because many vehicle operators suffer from hearing loss and will not be aware of this important warning.

### SUMMARY OF THE INVENTION

A wear indicator is provided that detects the wear condition of an automobile brake pad. The wear indicator includes an electrical connection that is interrupted as the brake pad wears beyond a particular point. In one embodiment, several of these electrical connections are provided so that the remaining life of the brake pad can be accurately predicted.

### BRIEF DESCRIPTION OF THE DRAWINGS

In the Figures:

FIG. 1 is a diagramatic view of a disc brake system incorporating the present invention.

FIG. 2 is a sectional view of a brake pad taken along 2-2.

FIG. 3 is a schematic representation of the electrical circuit of the present invention.

FIG. 4 is a top view of a sensor incorporating the present invention.

It is noted that the drawings of the invention are not to scale.

### DETAILED DESCRIPTION OF THE PREFERRED EMBODIMENT(S)

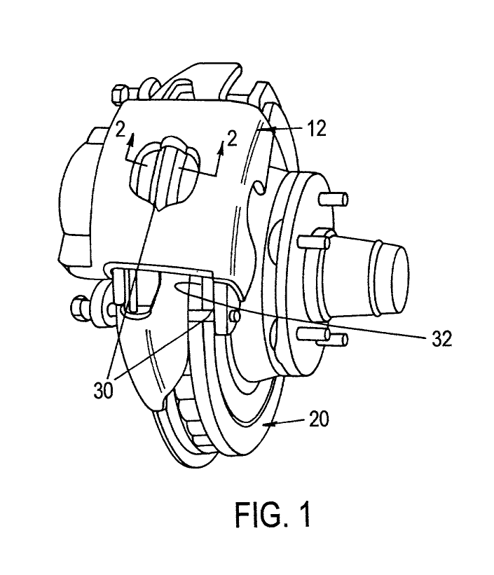

A brake system 10 is shown in FIG. 1. Brake system 10 is shown as a disc brake, but could also be a drum or other frictional braking system. Brake system 10 includes a rotor 20 and a brake pad 30, also sometimes called a brake shoe. The rotor 20 is attached to and rotates with the wheel (not shown) of the vehicle. The brake pad 30 is stationary relative to the rotor 20. The brake system 10 further includes a caliper 12 holding the brake pad 30. When braking is desired, the caliper 12 is activated and, using pneumatic or hydraulic activation, pushes the brake pad 30 into physical contact with the rotor 20. The amount and degree of braking can be varied by increasing or decreasing the pressure at which the brake pad 30 is held against the rotor 20. As the rotor 20 rotates with the brake pad 30 engaged against it, the frictional forces on the brake pad 30 will cause the contact surface 32 to wear away.

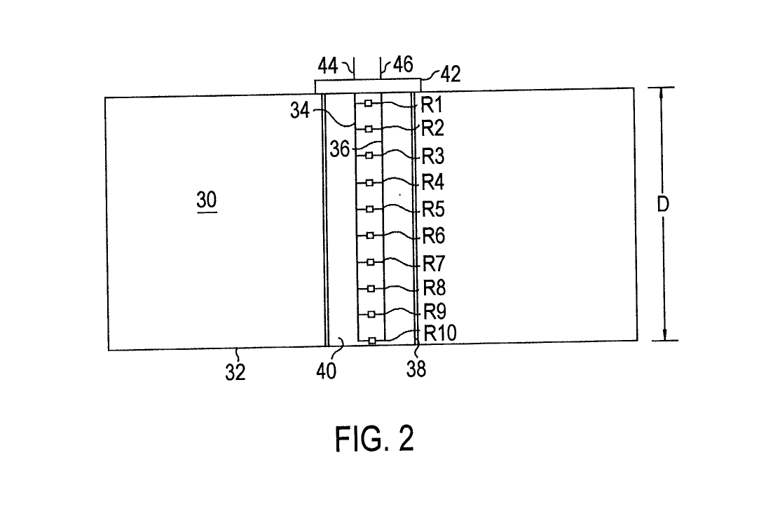

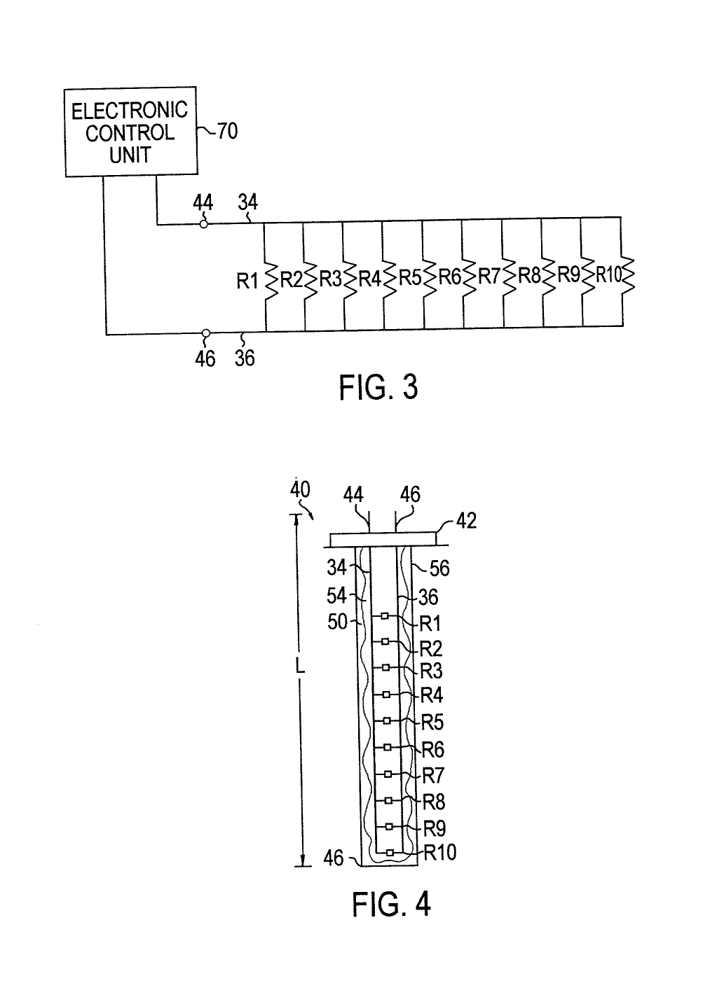

FIG. 2 shows a cutaway of a brake pad 30 incorporating the present invention. Resistors R1-R10 are incorporated into the brake pad 30. Electrically conductive traces 34,36 are provided to electrically connect the resistors R1-R10 in parallel. In this way, the resistor network shown schematically in FIG. 3 is provided. The electrically conductive traces 34,36 are provided running through substantially all of the depth D of the brake pad 30. The resistors R1-R10 are preferably thick film resistive devices screened onto the brake wear sensor 40 during manufacturing.

The equivalent resistance of resistors connected in parallel is defined by the equation:

$$\frac{1}{{R}_{equivalent}} = \sum \frac{1}{{R}_{i}} ,$$

where Rᵢ is the resistance of each resistor in the circuit. If all the resistors have an equal value, the total equivalent resistance can be defined as:

$${R}_{eq} = \frac{R}{N}$$

Where R is the resistance of each resistor and N is the number of resistors in parallel. For example, if each of the ten resistors was set at 1,000 Ω, the equivalent resistance of the new sensor would be 100 Ω. This arrangement allows a control system to easily determine the wear condition of the brake pad 30.

In practice, as the contact surface 32 wears away, the depth D will decrease. The length L of the brake wear sensor 40 will correspondingly decrease. As the length L decreases, R10 will become exposed. As the contact surface 32 further wears, the electrical connection of R10 will be broken. This will result in the resistor network having one less resistor across it. By detecting the resistance of the network, an indication can be provided that the brake pad 30 is worn between the level of R10 and R9. As the contact surface continues to wear, the electrical connection of R9 will be broken in like manner. At this point, the total resistance of the resistor network will become R8. The brake pad 30 can now be determined to be worn between the level of R9 and R8. This will continue until finally R1 is severed. At this point, the system will provide an open circuit and the wear detector will be alerted of an unsafe condition requiring service. If desired, the electronic control for the vehicle can prevent or minimize further operation of the vehicle.

Ideally, the break wear sensor 40 would be pressed into the brake pad 30. Brake pad 30 includes a receiving cavity 38 of a diameter sufficient to allow brake wear sensor 40 to be inserted with an interference fit. After insertion, the brake wear sensor 40 could be secured in place using a variety of means including rivets, screws, bolts or adhesive material. Brake wear sensor 40 includes a connector 42 which has electrical terminals 44,46 which are in turn electrically connected to the electrically conductive traces 34,36. Brake wear sensor 40 is ideally suited for insertion into the brake pad 30, but could also be mounted at one end of the brake pad 30 as an element to be added independently of the brake pad 30. Additionally, a plurality of brake wear sensors 40 could be placed at various positions around the brake pad 30. By analyzing the differences in wear detected by the various sensors, uneven wear of the brake pad 30 could be detected before any noticeable degradation in brake performance occurs.

The brake wear sensor 40 is made of a high temperature substrate 50. Substrate 50 is selected to be a material that will wear without causing any damage to rotor 20 in use. Substrate is also selected to wear in use rather than break or crack. Substrates suitable for this use include copper, brass or bronze among others.

After the substrate is cleansed to minimize foreign particles, a dielectric layer may be applied. The dielectric layer will not be required if a non-conducting substrate is chosen such as a ceramic material. It is envisioned, however, that a conductive material will be selected as a substrate and the dielectric material will therefore be required. The dielectric material can be screened onto the substrate and then the assembly is kiln-fired at 850° C. Electrically conductive traces 34,36 are next screened onto substrate 50. After the conductive traces are screened onto the substrate 50, the substrate 50 is again kiln fired at 850° C. Thick -film resistive materials are next screened onto substrate 50 connecting the electrically conductive traces 34,36 to form the circuit of FIG. 3. The thick-film resistive material is selected to provide the desired resistance value and is screened in parallel down the length of the substrate 50 as shown in FIG. 4. After the thick-film resistive materials are screened onto the substrate 50, the substrate 50 is again kiln fired at 850° C. A coating 54 is then applied to the brake wear sensor 40 to insulate the materials against the harsh environment of the brake system. The brake wear sensor 40 then receives connector 42 at a mounting end 56. This finished sensor assembly can then be provided as a component to the brake pad 30 manufacturer for incorporation as described above.

The electronic control unit 70 for the automobile is electrically interconnected to brake wear sensor 40 via connector 42. The electronic control unit 70 senses the resistance of the brake wear sensor preferably by providing a known voltage across connector terminals 44,46. The current can be determined by the electronic control unit and, by dividing the voltage by the current, the resistance can be determined. The electronic control unit 70 senses the resistance of the brake wear sensor 40 only when the brakes are not being applied. This is done because when the brakes are applied it is possible for the rotor to provide a short circuit across the electrically conductive traces 34,36 that are exposed as the brake wear sensor 40 is worn. If the rotor 20 provided a short circuit in this manner, the resistance of the brake wear sensor 50 would not provide an accurate indication of brake wear. The electronic control unit 70 can detect that the brakes are not being applied either through an additional brake pedal sensor or through the operating condition of the vehicle.

If, for example, ten resistors are used with a resistance of 10,000 Ω each, the initial resistance sensed by the electronic control unit 70 would be 1,000 Ω. After the brake wear sensor 40 was worn so the first resistor was open, the sensed resistance will decrease to 900 Ω. After the next resistor is worn away, the electronic control unit will sense 800 Ω. This will continue until all resistors are worn away, in which case the electronic control unit 70 will detect an open circuit.

The electronic control unit 70 will preferably be able to provide an indication of the brake pad 30 condition to the vehicle operator through an indicator light or other indication signal. Ideally, the electronic control unit 70 could provide an indication of the brake pad 30 remaining life based upon the existing resistance and the usage history in that vehicle. For example, if the electronic control unit 70 stores the initial mileage at the initial installation of the brake wear sensor 50, it can store the mileage as each of the resistors R1 . . . R10 are worn away. Using additional data from a brake pedal sensor, the electronic control unit can determine the approximate usage of the brakes per road mile by the particular vehicle. The electronic control unit 70 could therefore provide some indication of the life remaining on the brake pad 30.

It should be apparent that the detailed description above is illustrative only and should not be taken as limiting the scope of the invention. Similarly, not all of the functions performed by the embodiment disclosed need be performed in any one mechanism or circuit. Accordingly, the invention should be understood to include all such modifications as come within the scope and spirit of the following claims and equivalents thereto.

What is claimed is:

1. A brake wear sensor for an automobile comprising:
a substrate;
a brake pad, the substrate mounted to the brake pad;
a series of resistors mounted to the substrate; and,
wherein, the resistors are electrically interconnected in parallel;

2. The brake wear sensor of claim 1 and further comprising:
the brake pad includes a cavity formed to receive the substrate, the substrate mounted in the cavity.

3. The brake wear sensor of claim 1 and further comprising:
the brake pad having a contacting surface and having a depth;
the substrate having a first end and a second end, a connector mounted at the first end and having a length defined by the first and second ends, the length being approximately equal to the initial depth of the brake pad so upon attachment of the substrate to the brake pad the second end of the substrate corresponds with the contacting surface of the brake pad.

4. The brake wear sensor of claim 3 and wherein
the brake pad depth decreases as the contacting surface wears upon application of frictional forces and the substrate decreases in length corresponding to the decrease in brake pad depth.

5. The brake wear sensor of claim 4 and wherein as the length decreases, resistors are eliminated from substrate.

6. A method of detecting a wear condition of a brake pad comprising the steps of:
providing a break wear sensor incorporating a series of resistors connected in parallel;
providing a brake pad for application against a rotating member, the application creating frictional forces and thereby braking the rotating member;
mounting the break wear sensor to the brake pad;
sensing the equivalent resistance of the series of resistors;
determining the wear condition of the brake pad.

7. The method of claim 6 and further comprising:
the brake wear sensor having an initial length, the resistors mounted along the length of the brake wear sensor;
the brake pad having an initial depth defined by the distance between a mounting surface and a contacting surface;
the depth decreasing due to the frictional forces;
the length of the brake wear sensor decreasing with the depth of the brake pad;
the resistors being removed from the parallel circuit as the length of the brake wear sensor decreases;
and wherein the step of determining the brake wear condition comprises the additional steps of comparing the initial equivalent resistance with the sensed equivalent resistance and determining the corresponding decrease in length of the brake wear sensor.

8. The method of claim 6 and further comprising the step of:
estimating the remaining life of the brake pad.

9. The method of claim 8 and further comprising the step of:
providing an indication to a vehicle operator of the remaining life of the brake pad.

10. In a vehicle having a plurality of rotating wheels, brake assemblies on the wheels including a rotor or drum that rotates with the wheels and a frictional brake pad of a predetermined depth that engages the rotor or drum, the brake pad decreasing in depth due to the frictional forces over time, a brake wear sensor comprising:
a substrate having a first end and a second end, and a length defined therebetween;
at least one resistor formed on the substrate between the first end and the second end;
the substrate being capable of being mounted to the brake pad and decreasing in length as the brake pad decreases in depth;
the resistor wearing off the substrate upon the substrate wear passing a predetermined length.

11. The brake wear sensor of claim 10 and further comprising:
an electronic control unit electrically interconnected to the resistor and wherein the electronic control unit is capable of determining a wear condition by sensing the condition of the resistor.

12. The brake wear sensor of claim 11 and further comprising:
the electronic control unit determining the expected remaining life of the brake pad based upon the sensed condition of the resistor.

13. The brake wear sensor of claim 10 and wherein:
the resistor is placed along the length of the substrate so that upon the resistor wearing off the substrate the depth of the brake pad is at a wear condition requiring service.

14. The brake wear sensor of claim 10 and wherein a plurality of resistors is formed on the substrate, the resistors electrically interconnected in parallel, the resistors formed at varying lengths along the substrate.

15. The brake wear sensor of claim 14 and wherein:
each of the resistors has approximately the same value.

16. The brake wear sensor of claim 14 and wherein:
the initial equivalent resistance for the brake wear sensor is known;
the length of the brake wear sensor can be determined by comparing the present equivalent resistance to the initial resistance and calculating the number of resistors no longer electrically interconnected.

17. A brake for an automobile having rotating wheels comprising:
a rotating member;
a brake pad with a contacting surface for engagement with the rotating member the brake pad having a depth;
an engagement mechanism for forcing the brake pad into frictional engagement with the rotating member;
the brake pad decreasing in depth with wear;
a brake wear sensor mounted to the brake pad;
the brake wear sensor including at least one electrical component;
and wherein, upon the brake pad depth decreasing, the electrical component providing a signal representing the wear condition of the brake pad.

18. The brake for an automobile of claim 17 and the brake wear sensor electrical component further comprising a resistor.

19. The brake for an automobile of claim 17 and the brake wear sensor electrical component further comprising a plurality of resistor s connected in parallel.

20. The brake for an automobile of claim 18 and wherein the resistor is a thick-film resistive device.
